(19) United States
(12) Patent Application Publication
(10) Pub. No.: US 2021/0219190 A1
(43) Pub. Date: Jul. 15, 2021

(54) Fine-Granularity RAN Slicing Control

(71) Applicant: Parallel Wireless, Inc., Nashua, NH (US)

(72) Inventor: Yang Cao, Westford, MA (US)

(21) Appl. No.: 17/146,492

(22) Filed: Jan. 11, 2021

Related U.S. Application Data
(60) Provisional application No. 62/959,447, filed on Jan. 10, 2020.

(51) Int. Cl. H04W 36/00; H04W 88/16; H04W 36/14

(52) U.S. Cl. CPC H04W 36/0022; H04W 36/14; H04W 88/16

(57) ABSTRACT

A method for providing 5G-RAN slicing control is disclosed, comprising:
providing a gateway having a Radio Access Network (RAN) interface for communicating with the at least one RAN, a core network interface for communicating with the at least one core network, and a processor;
processing, by the processor, 5G signaling received from the at least one RAN on the RAN interface and providing core signaling to at least one core network;
processing, by the processor, signaling received from the at least one core on the core network interface and providing 5G RAN signaling to at least one RAN; and
providing network slicing, enabling building of multiple logical networks for different services across any of the at least one RAN and any of the at least one core network.

### CROSS-REFERENCE TO RELATED APPLICATIONS

This application claims priority under 35 U.S.C. § 119(e) to U.S. Provisional Pat. App. No. 62/959,447, filed Jan. 10, 2020 and titled “Fine-Granularity RAN Slicing Control,” which is hereby incorporated by reference in its entirety for all purposes. This application hereby incorporates by reference, for all purposes, each of the following: U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850US01); US20170272330A1 (PWS-71850US02); and Ser. No. 15/713,584 (PWS-71850US03). This application also hereby incorporates by reference in their entirety U.S. patent application Ser. No. 16/424,479, “5G Interoperability Architecture,” filed May 28, 2019; and U.S. Provisional Pat. Application No. 62/804,209, “5G Native Architecture,” filed Feb. 11, 2019.

### BACKGROUND

5G is the next generation Mobile Communication technology following 4G/LTE. The 3^{rd} Generation Partnership Project (3GPP) has been working on defining the standards for 5G as part of 3GPP Rel. 15 and 16. Starting with analog cellular (1G) and then followed by 2G, 3G and 4G, each generation has the laid the foundation for the next generation in order to cater to newer use cases and verticals. 4G was the first generation that introduced flat architecture with all-IP architecture. 4G enabled and flourished several new applications and use cases. 5G is going to be not just about higher data rates but about total user experience and is going to cater to several new enterprise use cases like Industrial automation, Connected Cars, Massive IOT and others. This will help operators to go after new revenue opportunities.

The standards for 5G are being finalized. 5G, the 3GPP version of ITU IMT-2020, is the main and only contender for the next generation of mobile technology. What is obvious to everyone is that 5G will be a natural evolution from 4G and will drive the ecosystem innovation to deliver enhanced customer experience while extending 4G network investments.

Parallel Wireless HetNet Gateway (HNG) enables a 5G ready architecture which is available to be deployed today. Enhancements to the HNG will allow a Non-standalone (NSA) deployment with LTE and 5G NR connected to EPC. With the availability of 5G Core (5GC), HNG will enable different 5G deployment options seamlessly, thereby reducing the complexity, Capex & Opex, from the operator.

Launching 5G network will need significant investment as it will need RAN and Packet Core upgrade. 3GPP has defined a new 5G NR and new 5G Core. Eventually all the operators will want to head towards a complete 5G network coverage with the new 5G Standalone Core, given the several new features and capabilities that the new 5G Standalone network brings in. But given the significant cost involved, 3GPP has defined number of different intermediate solutions that can provide gradual migration from current 4G network to the eventual native 5G network.

### SUMMARY

A wireless network system is described. In one embodiment the system includes at least one of a Non-Stand-Alone (NSA) base station and a Stand-Alone (SA) base station and a 5G enhanced HetNet Gateway (HNG) in communication with at least one of the NSA base station and the SA base station, the 5G enhanced HNG including interfaces for any G base station and interfaces for any core network. The system further includes a core network in communication with the 5G enhanced HNG, the core network including at least one of an Evolved Packet Core (EPC) and a 5G Core (5GC) and wherein the 5G enhanced HNG abstracts core functionality for EPC and for the 5GC, thereby providing distributed core functionality.

### BRIEF DESCRIPTION OF THE DRAWINGS

FIG. 1 is a schematic overview of network slicing, in accordance with some embodiments.

FIG. 2 is a schematic overview of network slicing using a coordinating gateway, in accordance with some embodiments.

FIG. 3 is a schematic overview of network slicing using a coordinating gateway slice pairing function, in accordance with some embodiments.

FIG. 4 is a schematic overview of end to end network slicing with dual slice pairing functions, in accordance with some embodiments.

FIG. 5 is a call flow showing RAN access and AMF selection in 5G core, in accordance with some embodiments.

FIG. 6 is a call flow showing RAN access and radio slice selection, in accordance with some embodiments.

FIG. 7 is a call flow showing network slice selection, in accordance with some embodiments.

FIG. 8 is a call flow showing end-to-end slicing creation at the core network, in accordance with some embodiments.

FIG. 9 is a schematic diagram of allocation of dynamic numerology, in accordance with some embodiments.

FIG. 10 is a schematic diagram of a multi-RAT core network, in accordance with some embodiments.

FIG. 11 is a system diagram of an enhanced base station, in accordance with some embodiments.

FIG. 12 is a system diagram of a coordinating server, in accordance with some embodiments.

### DETAILED DESCRIPTION

As the future of 5G is still being defined, there is much uncertainty around what 5G will actually be once it comes to fruition. If the main goal of 5G is to improve people's lives, the development of 5G should consider the various use cases for 5G. Additionally, 5G networks should seek to address the challenges faced by current 2G, 3G, 4G network architectures.

Varying network maturity in different regions requires a solution that can address older (2G, 3G, 4G) generation technologies while managing future (5G) networks—what will work for the more advanced market likely won't be a good option for less developed markets. One example of this is the Indian market, which still largely uses 3G networks and is still making investments into 4G. If 5G is set to be another air interface introduced within the next five years, this surely does not mean that networks in India and other countries with older generation networks will have to simply skip over 4G. Another example of this is in Western European markets where 4G LTE investments are projected to increase dramatically over the next few years.

The defining challenge of the next ten years will be to efficiently deploy and manage networks that are becoming more complex in order to address the challenges of increasing data usage and higher density. The issue with managing these networks is that they comprise of several different technologies and air interfaces.

A coordinating gateway, herein described as a HetNet Gateway (HNG), can play a central role in orchestrating the slicing functionality in 4G, and in future, in the 5G networks, in some embodiments. This multi-RAT coordinating gateway may be a system that sits between the core network and the RAN, and abstracts, or virtualizes, the core network toward the RAN and the RAN toward the core network, such that various radio access networks (RAN nodes) having various radio access technologies (RATs, e.g., 2G, 3G, 4G, 5G) are made able to interwork with core networks having a different RAT (e.g., a 4G core supporting some combination of 2G, 3G, 4G, 5G RAN nodes). Further description of the coordinating gateway is provided in at least the documents included by reference herein.

In 5G network communication infrastructure is not just continued to mobile voice/text communication, it is now segregated and very diversified to different services, like Industrial IoT, Smart home domestic IoT, Low latency Medical communication, high bandwidth mobile broadband etc. And each of these services require different data behavior and QoS from network infrastructure.

In 5G each network node is equipped with special features to serve the purpose of one or multiple services and the kind of service supported by a particular node is defined in NSSF (Network Slice Selection Function). For any particular service request from UE, is served by a set of network entities associated with that Service and called a network slice. Network slices as understood in 5G are designed to be end-to-end, with network resources being identified from the radio carrier, to the radio access network node, to the transport/backhaul, to the core network node, such that the identified resources are working together as if they were one independent network exclusively serving the users on that network slice and providing quality of service guarantees specific to that network slice.

While the description details the use of 5G, and while network slices and network slicing are a concept introduced with 5G, in some embodiments, due to the use of a multi-RAT coordinating gateway, it is not limited to only 5G but can be extended to other Gs as well. In some embodiments, signals are routed through the HNG and slice pairing is performed (2G, 3G, 4G) to an underlying slice in the core network using 5G slice protocols.

In some embodiments, a coordinating node can use an NSSAI (network slice assistance information). Each NSSAI has multiple S-NSSAI (single NSSAI) slices. Each S-NSSAI slice has multiple DNNs configured. A configured NSSAI can be configured by a serving PLMN or default NSSAI configured by HPLMN. If Serving PLMN doesn't have specifc configured PLMN then it uses default configured NSSAI from HPLMN. These ideas are roughly applicable not only to 5G but to slices that use resources in another G or across multiple Gs. NSSAI is further specified in 3GPP TS 29.531 v.15.0.0, “Network Slice Selection Services,” hereby incorporated by reference in its entirety for all purposes.

UE is pre-configured/provisioned by signalling message with default configured NSSAI by HPLMN.

UE is only configured with a set of subscribed S-NSSAIs out of the default configured NSSAI, which is a subset of the S-NSSAIs configured inside default cofigured NSSAI in HPLMN.

Allowed S-NSSA is provided to the UE can have values, which are not served by Serving PLMN, in that case Serving PLMN updates the allowed S-NSSAI list with mapping to corresponding S-NSSAI of the HPLMN.

S-NSSAI and its Structure

Each Slice is identified by S-NSSAI (single network slice selection identifier) as shown in Table 1.

TABLE 1

| | |
|---|---|
| Slice/Service Type (SST) | Slice Differentiator (SD) |

SST is required value where was SD is optional SST refer to expected behaviour of the slice.

SD is optional and differentiates among multiple slices with same SST.

UE during Registration and PDU session Establishment sends S-NSSAI value and optionally HPLMN NSSAI value, if in visiting area.

The requested NSSAI signalled by UE to network allows the network to select appropriate serving AMF, Network slice and network slice instance.

Based on the subscription data, one UE can have subscription to multiple S-NSSAIs and one of them can be marked as default S-NSSAI.

Subscription information for each S-NSSAI may have multiple DNN and one of them is default DNN.

Services provided by NSSFare shown in Table 2

TABLE 2

| | | Reference in |
|---|---|---|
| Service Name | Description | TS 23.502 [3] |
| Nnssf_NSSelection | Provides the requested | 5.2.16.2 |
| | Network Slice information | |
| | to the Requester. | |
| Nnssf_NSSAIAvailability | Provides NF consumer on | 5.2.16.3 |
| | the availability of | |
| | S-NSSAIs on a per | |
| | TA basis. | |

Nnssf_NSSelection_Get service operation

May be invoked during Registration, for serving AMF selection and re-allocation. PDU session establishment procedure, for SMF selection.

UE configuration update procedure, to update allowed S-NNAIs to UEs in current serving PLMN.

Nnssf_NSSAIAvailability

Nnssf_NSSAIAvailability_Update: In this process, AMF updates NSSF with S-NSSA is supported by AMF per TA and gets back availability of S-NSSA is for each TA.

Nnssf_NSSAIAvailability_Notify: AMF notify NSSF with restricted S-NSSAIs per TA using this procedure.

AMF Re-allocation Procedure During UE registration procedure, if AMF doesn't support one or more requested S-NSSAIs which is allowed by SPLMN/HPLMN then it request NSSF to provide the appropriate AMF to redirect the registration request from UE.

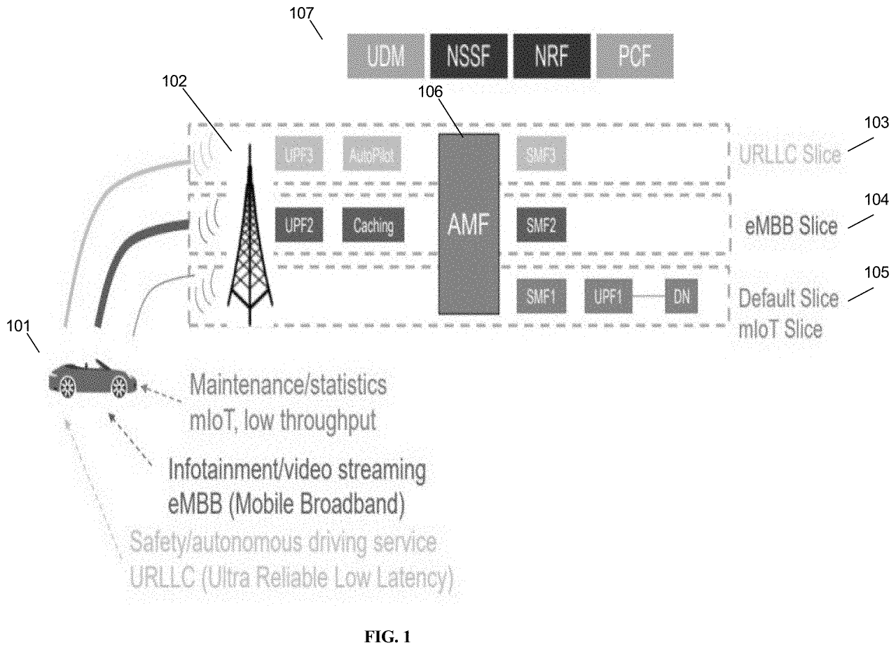

FIG. 1 is a schematic overview of network slicing, in accordance with some embodiments. A car 101 is shown with multiple network clients, including one client that requires low throughput (machine/Internet of Things or mIoT), one that requires ultra reliable low latency (URLLC), and one that requires video streaming mobile broadband (eMBB). Each of these clients uses a different slice, which includes various network resources deployed end to end, here shown as URLLC slice 103, eMBB slice 104, and default slice (mIoT slice) 105. The different slices provide different guarantees. The slices all utilize and share RAN node 102. AMF 106 is part of each slice and is responsible for coordinating the slices, as well as required communication with 5GC 107.

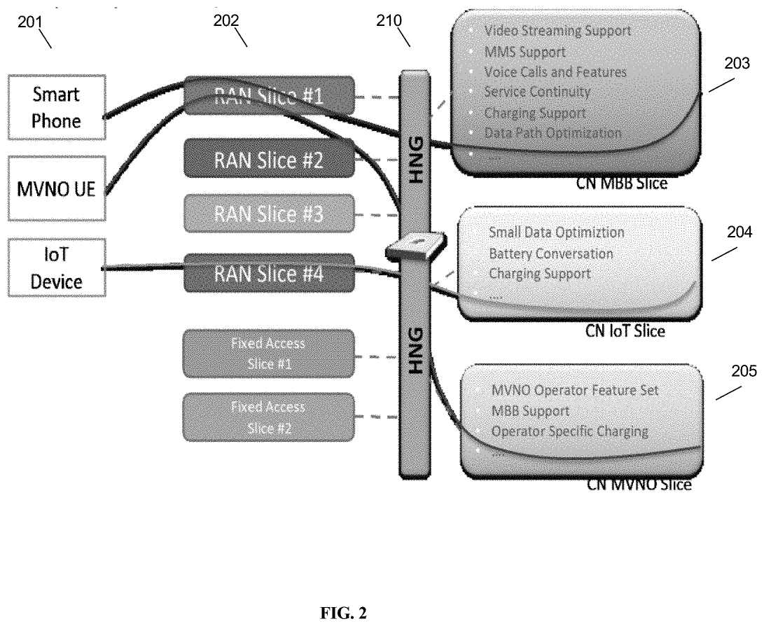

FIG. 2 is a schematic overview of network slicing using a coordinating gateway, in accordance with some embodiments. User devices 201 (smartphone, MVNO UE, IoT device) utilize various combinations of RAN slices 202 and core slices 203 (MBB), 204 (IoT), 205 (MVNO). (The MVNO slice is a slice that provides network resources that have been paid for by the virtual mobile network operator or MVNO.) Different slices provide different sets of services as listed in the figure. Note that a HNG 210 is providing a coordinating function to match user devices 201, RAN slices 202, and core slices 203, 204, 205.

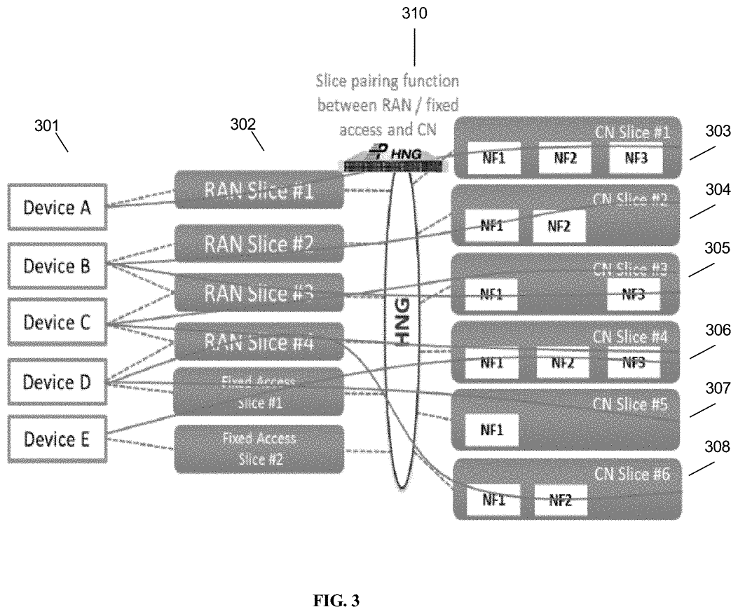

FIG. 3 is a schematic overview of network slicing using a coordinating gateway slice pairing function, in accordance with some embodiments. Here, as in FIG. 2, an HNG is provided, but as shown a slice pairing function 310 exists to match devices 301, RAN slices 302, and core network slices 303, 304, 305, 306, 307, 308.

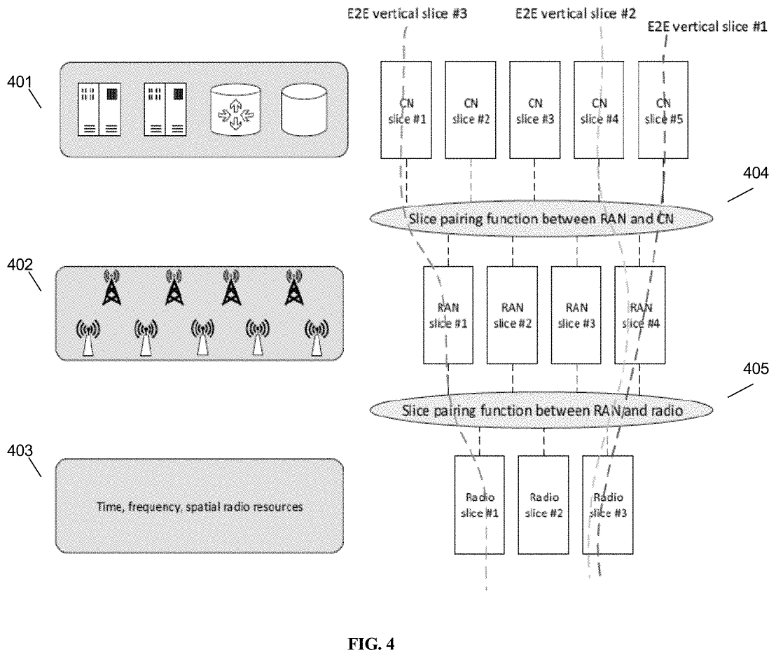

FIG. 4 is a schematic overview of end to end network slicing with dual slice pairing functions, in accordance with some embodiments. This is a diagram showing the slicing in a vertical orientation. Core network 401, RAN nodes 402, and radio resources 403 are shown. As well, end to end vertical slices are shown. Note that a slice pairing function between RAN and CN 404 is placed between the RAN and the core, and a slice pairing function between the RAN and the radio 405 is also shown. A coordinating node or HNG can provide both 404 and 405 pairing functions and may be located at an appropriate place in the network, e.g., at the edge of the network.

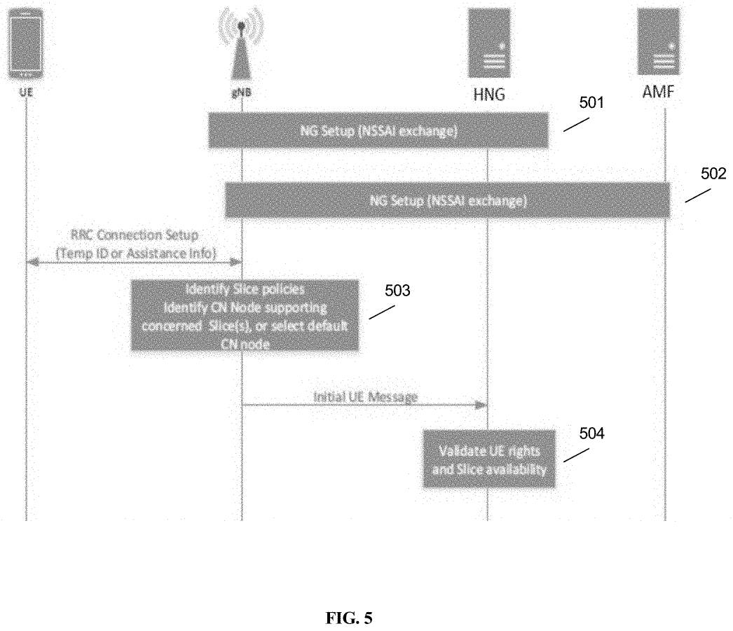

FIG. 5 is a call flow showing RAN access and AMF selection in 5G core, in accordance with some embodiments. NG setup 501 involves the HNG, where an NSSAI is negotiated with the HNG and also then negotiated with the 5GC AMF 502. Once the slice ID is identified, the slice policies, CN resource etc. are identified at the gNB 503, and then when the UE connects to the HNG, the coordinating node validates UE rights 504.

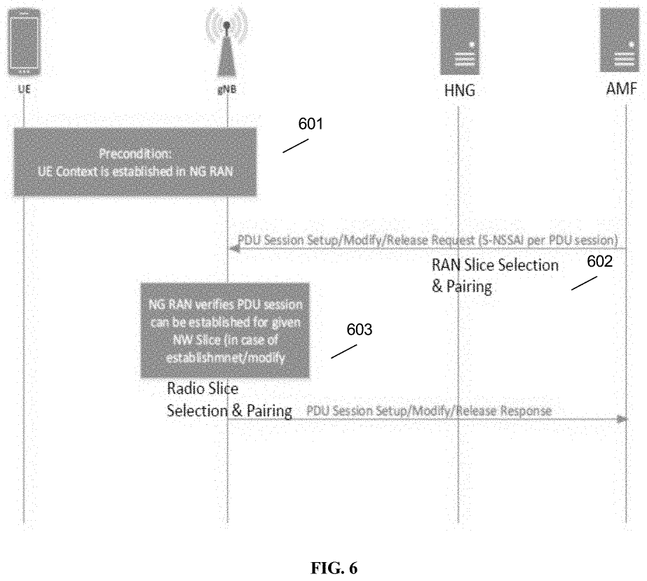

FIG. 6 is a call flow showing RAN access and radio slice selection, in accordance with some embodiments. At 601, a precondition is that UE context is established in the RAN node (gNB). Once the context is set up, the 5GC can modify (setup/modify/release; S-NSSAI per PDU session) the session and at that time the HNG can provide a RAN slice selection and pairing function 602. Now the gNB verifies that the PDU session can be established 603 and also performs radio slice selection and pairing, in some embodiments in coordination with the HNG.

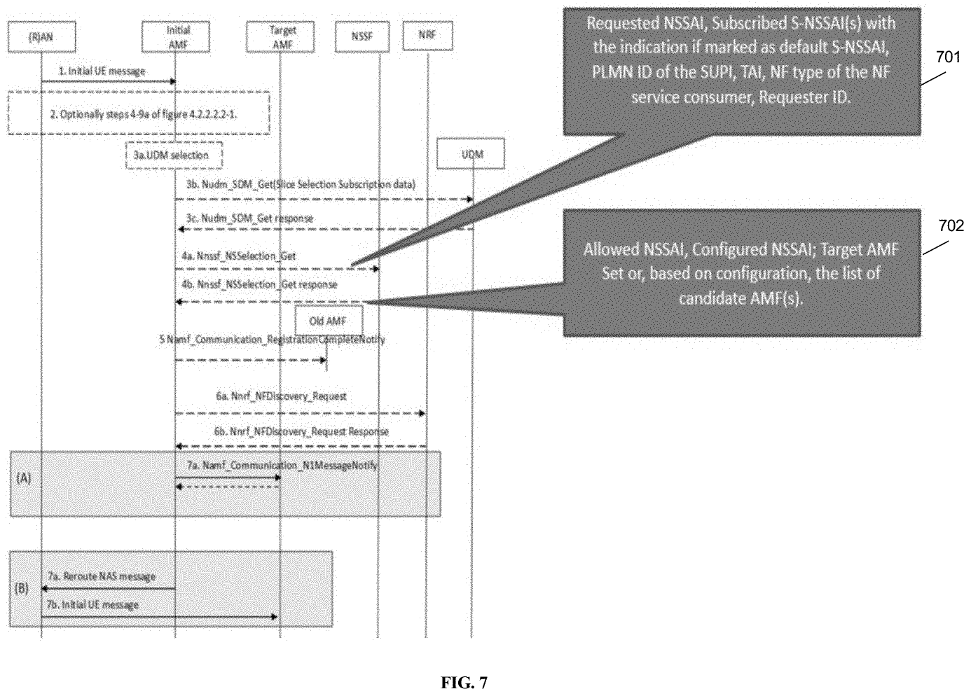

FIG. 7 is a call flow showing network slice selection during handover, in accordance with some embodiments. At step 701, a requested NSSAI is requested from the initial AMF to the target AMF to the slice selection function in the target network. Then at step 702 the allowed network slice is set up. This is considered to be possible across RATs as well, in some embodiments, utilizing the core network abstraction of the HNG.

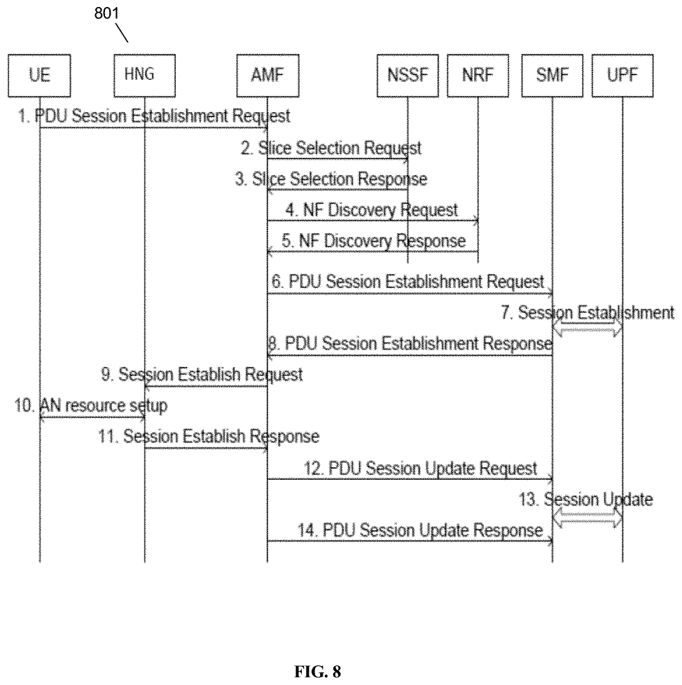

FIG. 8 is a call flow showing end-to-end slicing creation at the core network, in accordance with some embodiments. In the core network the HNG is responsible for resource setup after resources are allocated by the core.

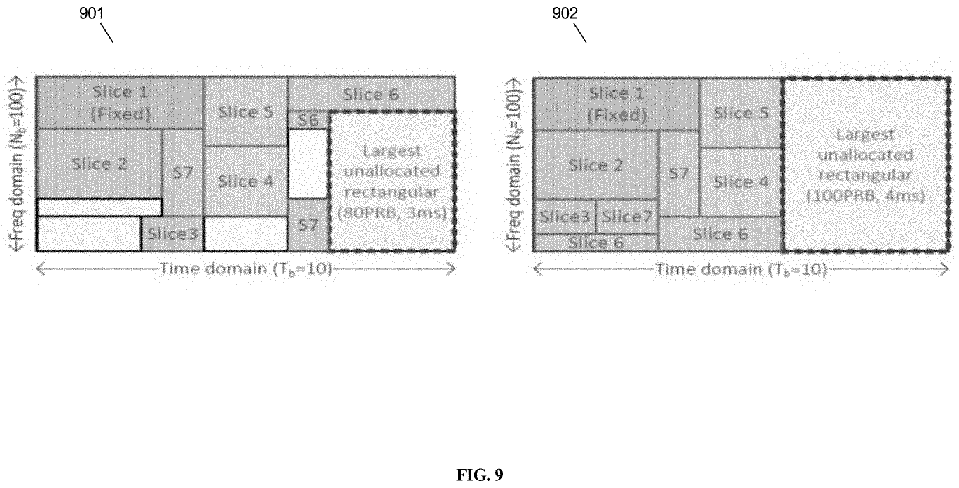

FIG. 9 is a schematic diagram of allocation of dynamic numerology in 5G, in accordance with some embodiments. The HNG (or in some cases the gNB) may perform radio slice selection and may allocate radio resources to provide services to a UE. If the UE requires high bandwidth, a large rectangular block of radio resources may be allocated (for example, to an eMBB slice). The HNG may manage this and may manage this for multiple RATs; alternately the gNB may manage this; alternately the gNB may take on this function for managing multiple RATs as well as 5G. Note that only 5G has a flexible numerology. The use of additional RATs may be understood to be additive to the 5G radio resource domain.

RAN and Radio slicing can be used to provide fine granularity differentiation control, in some embodiments. This can be accomplished by one or more of dynamically adjusting numerology and pre-emption scheme, joint RAN slicing and mobile edge computing, dynamically pairing with appropriate radio slicing, dynamic inter-RAT switching and further Ran-slicing differentiation using dynamic modulation adjustment based on SINR. Radio slicing differentiation allows dynamically adjusting transmit power, dynamically adjusting transmit beamforming and dynamic MIMO scheme selection.

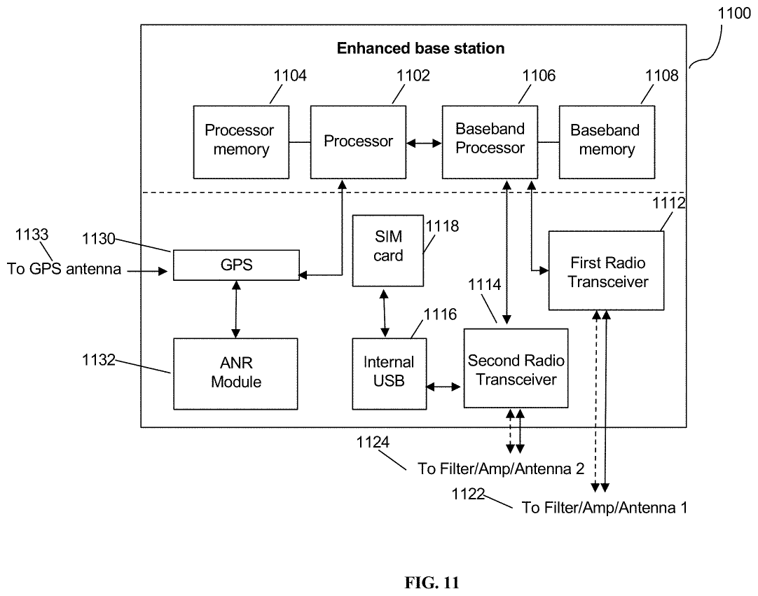

In some embodiments some combination of the following may be used for differentiation control. RAN slicing—dynamic inter-RAT switching allows dynamically adjusting RAT technology such as switching between LTE and NR or DC if needed. In some embodiments, Switching front-end radio to Wi-Fi may be considered, in some embodiments, particularly for eMBB requirements. Switching radio to device-to-device may be considered, if possible. In all these cases it may be anchored with a 5G core, as shown in FIG. 11.

Two slices may be paired, the RAN slice and Core slice. The HNG sits between these—slice pairing function. For example, the core slice is further described. The 5G spec already has a slice pairing function. However, this is not well defined in the 4G or other RAT space. This is one of the key roles of the HNG.

As well, the HNG plays a key role in understanding RAN slices. In 4G core, Qos flows, DSCP, diffserv, MPLS, marking schemes, etc have already been well developed and defined. But the RAN slice, in terms of using these RAN technologies to differentiate with fine granularity has not been well defined.

Several examples of RAN slices and RAN slice pairing at the HNG are described, in accordance with some embodiments.

Eg: 4 g subcarrier spacing numerology is fixed at 15 khz. But in 5G, it can be 15 k, 30 k, 60 k, 120 k. Once you change the numerology on the frequency side, there is a duality on the time side (when you double width on the freq, you are halving the time slot on the time side). So, it follows that, if you have time sensitivity, you want a wide freq numerology, and you can tile these with other blocks. And HNG can construct these tiled slices.

Eg: Adaptive beamforming. Use different characteristics of beamforming to tie with RAN slice.

Eg: preempting. We define eMBB and also ultrareliable services. Preempting. This can be integrated with RAN slices.

Eg: energy and power savings. If you need ultrareliable service, keep the power on for those antennas. Otherwise turn power on or off as needed, enabling power savings.

Eg: spectrum sharing. If you need ultrareliable service, you dedicate the spectrum. Otherwise share spectrum as needed.

The new 5G RAN properties can thus be enabling schemes for constructing a new semantics of RAN slice.

As well, the standard does not define how to make these RAN slices happen, particularly in circumstances of: heterogeneity of our resources; stack from one vendor and radio from another vendor; and, inter-RAT handover or inter-RAT slicing. The network slice manager described herein may track and allocate resources with granularity and may facilitate effective matching, in accordance with some embodiments.

One general scheme for EMBB (high bitrate), one general scheme for ultrareliable/low latency, one general scheme for IoT may be disclosed, for example, in some embodiments. For example, a scheme may rely on UE feedback, RAN condition, UE signal strength/quality (eg SINR). eg, 256 QAM does not work for low SINR UE.

In some embodiments, Consider UE feedback and also other UEs' feedback and Periodically perform a rebalancing for all UEs may be considered. This would happen both at a long period and also at an intermediate period at the HNG; this could be fixed or could be tied into the policies, eg, streaming. Assign certain policies to normal streaming, or preferred streaming due to contractual obligations, in some embodiments, Or, eg, low latency services. Can assign different policies to different company's cars or different hospital's surgeons.

The network slicing functionality contains access network slices, core network slices and the selection function in the HNG that connects these slices into a complete network slice comprised of both the access network and the core network. The selection function routes communications to an appropriate CN slice that is tailored to provide specific services. The criteria of defining the access slices and CN slices include the need to meet different service/applications requirements and to meet different communication requirements.

Each core network slice is built from a set of network functions (NFs). An important factor in slicing is that some NFs can be used across multiple slices, while other NFs are tailored to a specific slice.

The new 5G system is service-based architecture (SBA). This means that wherever suitable the architecture elements are defined as network functions that offer their services via interfaces of a common framework to any network functions that are permitted to make use of these provided services. NRF or Network repository functions allow every network function to discover the services offered by other network functions. This architecture model, which further adopts principles like modularity, reusability and self-containment of network functions, is chosen to enable deployments to take advantage of the latest virtualization and software technologies.

To enable early adopters of 5G technology to launch commercial services with New Radio (NR), the NSA approach allows to use an existing 4G Mobile Core Network and ease the transition to the Next Generation Core (NGC) once it is available.

Multiple-Access/Multiple-Service Networks: In addition to the network supporting both 4G and 5G RAN, the 5G Core Network will have a deeper integration of access technologies like WiFi and Fixed Access. The main vision of 5G core networks is to have common control and user planes regardless of the access type(s) being used. While this requirement adds complexity to the overall solution and its deployment, it grants enormous flexibility for multi-service operators.

End to End Network Slicing: in order to support the different type of services shown above and over a common network, the network resources—all the way from the RAN to the Internet Access—will include the ability to have End-to-End ‘slices’, each of them with their own performance characteristics, isolated from the other slices. Each slice will have a different QoS, security considerations, latency characteristics, Inline Services, etc. For example, the network characteristics for a Best Effort IoT slice will differ significantly from a high-end Enterprise slice (think throughput, latency, always-on vs intermittent connection, data volume, voice vs data-only)

Fully virtualized Next Generation core (NGC): the transformation on mobile networks initiated with virtualization of the mobile core in 4G (away from chassis/proprietary hardware), has become a pillar of 5G networks. Requirements in this area go beyond the mere use of VM-based Virtual Network Functions (VNF), but as an evolution towards cloud-native architectures. The IT model of deployment (as cloud-giants like Amazon have done for e-commerce) is being applied to the Telecom industry. Automation and Orchestration of such virtualized solutions is a necessity as well. The ability to separate Control and User planes is also a basic requirement of 5G networks. As discussed earlier, HNG will play a key role in the 5G network architecture to simplify the deployment of 5G network and the 5G migration strategy.

If slice ID is globally unique, can do multi- and inter-rat slicing. Note that slice pairing cold be done without HNG. Slice ID is NSSAI, assigned by NSSAF, could be multi-RAT also.

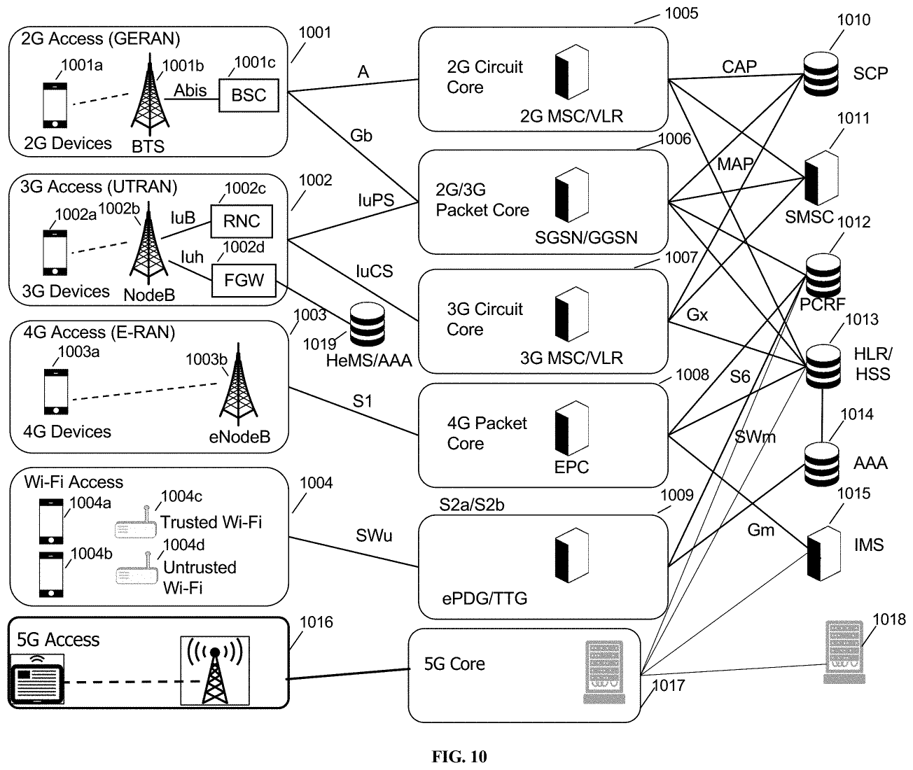

FIG. 10 is a schematic network architecture diagram for 3G and other-G prior art networks. The diagram shows a plurality of “Gs,” including 2G, 3G, 4G, 5G and Wi-Fi. 2G is represented by GERAN 1001, which includes a 2G device 1001a, BTS 1001b, and BSC 1001c. 3G is represented by UTRAN 1002, which includes a 3G UE 1002a, nodeB 1002b, RNC 1002c, and femto gateway (FGW, which in 3GPP namespace is also known as a Home nodeB Gateway or HNBGW) 1002d. 4G is represented by EUTRAN or E-RAN 1003, which includes an LTE UE 1003a and LTE eNodeB 1003b. Wi-Fi is represented by Wi-Fi access network 1004, which includes a trusted Wi-Fi access point 1004c and an untrusted Wi-Fi access point 1004d. The Wi-Fi devices 1004a and 1004b may access either AP 1004c or 1004d. In the current network architecture, each “G” has a core network. 2G circuit core network 1005 includes a 2G MSC/VLR; 2G/3G packet core network 1006 includes an SGSN/GGSN (for EDGE or UMTS packet traffic); 3G circuit core 1007 includes a 3G MSC/VLR; 4G circuit core 1008 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 1030, the SMSC 1031, PCRF 1032, HLR/HSS 1033, Authentication, Authorization, and Accounting server (AAA) 1034, and IP Multimedia Subsystem (IMS) 1035. An HeMS/AAA 1036 is present in some cases for use by the 3G UTRAN. The diagram is used to indicate schematically the basic functions of each network as known to one of skill in the art, and is not intended to be exhaustive. For example, 5G core 1017 is shown using a single interface to 5G access 1016, although in some cases 5G access can be supported using dual connectivity or via a non-standalone deployment architecture.

Noteworthy is that the RANs 1001, 1002, 1003, 1004 and 1036 rely on specialized core networks 1005, 1006, 1007, 1008, 1009, 1037 but share essential management databases 1030, 1031, 1032, 1033, 1034, 1035, 1038. More specifically, for the 2G GERAN, a BSC 1001c is required for Abis compatibility with BTS 1001b, while for the 3G UTRAN, an RNC 1002c is required for Iub compatibility and an FGW 1002d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

FIG. 11 shows is an enhanced eNodeB for performing the methods described herein, in accordance with some embodiments. eNodeB 1100 may include processor 1102, processor memory 1104 in communication with the processor, baseband processor 1106, and baseband processor memory 1108 in communication with the baseband processor. Mesh network node 1100 may also include first radio transceiver 1112 and second radio transceiver 1114, internal universal serial bus (USB) port 1116, and subscriber information module card (SIM card) 1118 coupled to USB port 1116. In some embodiments, the second radio transceiver 1114 itself may be coupled to USB port 1116, and communications from the baseband processor may be passed through USB port 1116. The second radio transceiver may be used for wirelessly backhauling eNodeB 1100.

Processor 1102 and baseband processor 1106 are in communication with one another. Processor 1102 may perform routing functions, and may determine if/when a switch in network configuration is needed. Baseband processor 1106 may generate and receive radio signals for both radio transceivers 1112 and 1114, based on instructions from processor 1102. In some embodiments, processors 1102 and 1106 may be on the same physical logic board. In other embodiments, they may be on separate logic boards.

Processor 1102 may identify the appropriate network configuration, and may perform routing of packets from one network interface to another accordingly. Processor 1102 may use memory 1104, in particular to store a routing table to be used for routing packets. Baseband processor 1106 may perform operations to generate the radio frequency signals for transmission or retransmission by both transceivers 1110 and 1112. Baseband processor 1106 may also perform operations to decode signals received by transceivers 1112 and 1114. Baseband processor 1106 may use memory 1108 to perform these tasks.

The first radio transceiver 1112 may be a radio transceiver capable of providing LTE eNodeB functionality, and may be capable of higher power and multi-channel OFDMA. The second radio transceiver 1114 may be a radio transceiver capable of providing LTE UE functionality. Both transceivers 1112 and 1114 may be capable of receiving and transmitting on one or more LTE bands. In some embodiments, either or both of transceivers 1112 and 1114 may be capable of providing both LTE eNodeB and LTE UE functionality. Transceiver 1112 may be coupled to processor 1102 via a Peripheral Component Interconnect-Express (PCI-E) bus, and/or via a daughtercard. As transceiver 1114 is for providing LTE UE functionality, in effect emulating a user equipment, it may be connected via the same or different PCI-E bus, or by a USB bus, and may also be coupled to SIM card 1118. First transceiver 1112 may be coupled to first radio frequency (RF) chain (filter, amplifier, antenna) 1122, and second transceiver 1114 may be coupled to second RF chain (filter, amplifier, antenna) 1124.

SIM card 1118 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 1100 is not an ordinary UE but instead is a special UE for providing backhaul to device 1100.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 1112 and 1114, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 1102 for reconfiguration.

A GPS module 1130 may also be included, and may be in communication with a GPS antenna 1132 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 1132 may also be present and may run on processor 1102 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

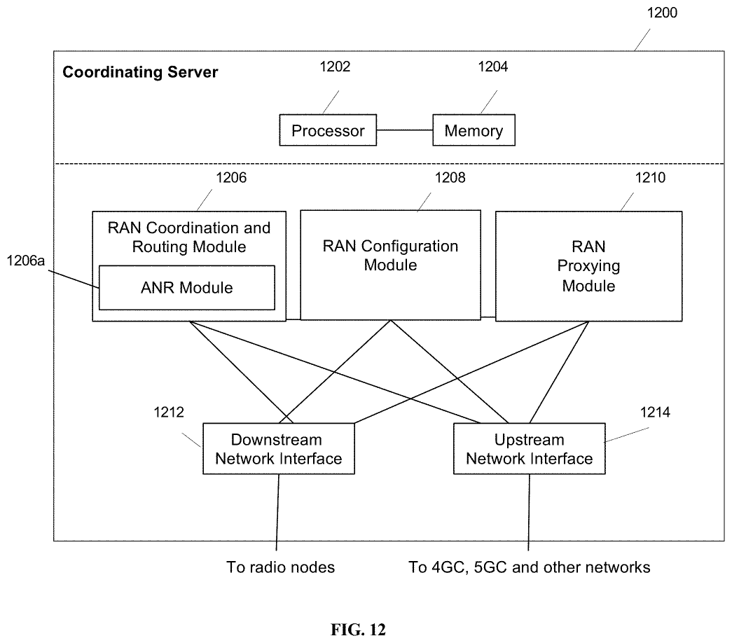

FIG. 12 shows a coordinating server for providing services and performing methods as described herein, in accordance with some embodiments. Coordinating server 1200 includes processor 1202 and memory 1204, which are configured to provide the functions described herein. Also present are radio access network coordination/routing (RAN Coordination and routing) module 1206, including ANR module 1206a, RAN configuration module 1208, and RAN proxying module 1210. The ANR module 1206a may perform the ANR tracking, PCI disambiguation, ECGI requesting, and GPS coalescing and tracking as described herein, in coordination with RAN coordination module 1206 (e.g., for requesting ECGIs, etc.). In some embodiments, coordinating server 1200 may coordinate multiple RANs using coordination module 1206. In some embodiments, coordination server may also provide proxying, routing virtualization and RAN virtualization, via modules 1210 and 1208. In some embodiments, a downstream network interface 1212 is provided for interfacing with the RANs, which may be a radio interface (e.g., LTE), and an upstream network interface 1214 is provided for interfacing with the core network, which may be either a radio interface (e.g., LTE) or a wired interface (e.g., Ethernet).

Coordinator 1200 includes local evolved packet core (EPC) module 1220, for authenticating users, storing and caching priority profile information, and performing other EPC-dependent functions when no backhaul link is available. Local EPC 1220 may include local HSS 1222, local MME 1224, local SGW 1226, and local PGW 1228, as well as other modules. Local EPC 1220 may incorporate these modules as software modules, processes, or containers. Local EPC 1220 may alternatively incorporate these modules as a small number of monolithic software processes. Modules 1206, 1208, 1210 and local EPC 1220 may each run on processor 1202 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method for providing 5G-RAN slicing control, comprising:
providing a gateway having a Radio Access Network (RAN) interface for communicating with the at least one RAN, a core network interface for communicating with the at least one core network, and a processor;
processing, by the processor, 5G signaling received from the at least one RAN on the RAN interface and providing core signaling to at least one core network;
processing, by the processor, signaling received from the at least one core on the core network interface and providing 5G RAN signaling to at least one RAN; and
providing network slicing, enabling building of multiple logical networks for different services across any of the at least one RAN and any of the at least one core network.
